(19) United States
(12) Patent Application Publication
(10) Pub. No.: US 2014/0116343 A1
(43) Pub. Date: May 1, 2014

(54) GAME FEEDER

(71) Applicant: David Collins, Fort Myers, FL (US)

(72) Inventor: David Collins, Fort Myers, FL (US)

(21) Appl. No.: 13/661,510

(22) Filed: Oct. 26, 2012

(51) Int. Cl. A01K 5/02

(52) U.S. Cl. 119/51.11; 119/57.91; 119/57.92

(57) ABSTRACT

A game feeder can include a housing having a cavity, an input aperture, and an output aperture; a base attached to the housing; a spreader below the output aperture; and a motor, attached to the feeder and the spreader, and configured to rotate the spreader. A feeder can include a varmint guard disposed below the output aperture, such that the spreader is between the guard and housing, to minimize interference and/or damage to the spreader or feeder by a varmint. A base can be provided as a single piece or base components configured to securely connect together to form the base.

### BACKGROUND OF THE INVENTION

Game feeders are used to attract game by providing feed for the game to consume.

### SUMMARY OF THE INVENTION

It is, therefore, an object of the present invention to provide a game feeder.

It is another object of the present invention to provide a game feeder having improved protection from vermin.

It is a further object of the present invention to provide a game feeder that is more easily transportable.

An exemplary embodiment of the present invention can include a housing, a base, a spreader, and a motor. The following are exemplary aspects of the present invention:
a housing can be formed by one or more walls, that define a cavity, and can include an input aperture located on an upper portion of the housing and an output aperture located on a lower portion of the housing;
a base can have a top portion that can be securely attached to the housing, and a bottom portion configured to securely engage a ground surface;
a spreader can be located directly below the output aperture;
a motor (mechanical or electric) can be securely attached to the game feeder and spreader, and can be configured to rotate the spreader when activated;
the housing, base, and spreader can be formed of one or more rigid materials;
when the housing is filled with feed via the input aperture, the feed can be gravity-biased to exhaust through the output aperture, and to statically abut the spreader when the spreader is not rotating; and
when the spreader is rotated via the motor, the spreader can spread exhausted feed away from the spreader.

The following are optional exemplary aspects of the present invention:
a game feeder can further include a varmint guard, disposed directly below the output aperture, and securely attached to the housing such that the spreader is disposed between the varmint guard and the housing;
a varmint guard can include a plurality of guard holes;
a clearance distance between a varmint guard and the housing can be between about 3 inches and about 0.125 inches, in any measurable increment there between;
the spreader can be provided as a spreader plate having at least one tab for spreading the feed;
the game feeder can further include a timer, and the motor can be a mechanical motor having a potential energy storage cell, with the timer being configured to transfer stored energy from the storage cell to the motor so as to rotate the spreader according to a schedule;
the game feeder can further include a timer, and the motor can be an electrical motor having a power supply, and the timer can be configured to transfer power from the power supply to the motor so as to rotate the spreader according to a schedule;
the motor can be disposed within the cavity for varmint protection;
the base can provided as a plurality of base components that are configured to securely connect together to form the base;

the plurality of base components can include a plurality of rails configured, to be aligned in parallel when the components are securely connected together, and to render the game feeder slidable along the ground surface;
the plurality of base components can further includes a plurality of cross members configured to securely connect together at least two of the rails;
the plurality of base components can further include at least one cross element configured to securely connect together at least two of the plurality of cross members;
the lower portion of the housing can include a plurality of legs, and the base can include a plurality of leg extensions configured to securely engage the legs; and
a game feeder can further include one or more loops disposed on the upper portion of the housing for hanging the game feeder and/or disposed on the base for pulling the game feeder.

Another exemplary embodiment of the present invention can include a housing, a loop disposed on an upper portion of the housing for hanging the feeder from a structure, a spreader, and a motor.

Notably, any exemplary aspect illustrated, shown, or described herein, can be utilized optionally with any embodiment of the present invention.

These and other exemplary aspects of the present invention are described herein.

### BRIEF DESCRIPTION OF THE DRAWINGS

The present invention is illustrated by way of example, and not in limitation, in the figures of the accompanying drawings, in which:

FIG. 1 illustrates an exemplary embodiment of the present invention having a housing, a base, a spreader, a motor, an optional varmint guard, and an optional access aperture and cover.

FIG. 2 illustrates a more details perspective of an exemplary spreader and varmint guard according to an exemplary embodiment of the present invention.

FIG. 3 illustrates another exemplary embodiment of the present invention having a motor, spreader, and varmint guard connected to a housing, according to exemplary aspects of the present invention.

FIG. 4 illustrates an exploded perspective of an exemplary base according to another exemplary embodiment of the present invention.

### DETAILED DESCRIPTION OF THE INVENTION

The invention will now be described in more detail by way of example with reference to the embodiments shown in the accompanying figures. It should be kept in mind that the following described embodiments are only presented by way of example and should not be construed as limiting the inventive concept to any particular physical configuration, material, or order. Further, exemplary embodiments and aspects between Figures are not to be construed in a limiting manner, and in particular, all combinations of all exemplary aspects are to be construed as embodiments independent of each other.

FIG. 1 illustrates an exemplary embodiment of the present invention, in which a game feeder 100 can include a housing 110, a base 120, a spreader 130, and a motor 140.

In an exemplary aspect of the present invention, housing 110 can be formed by one or more walls 111 that define a cavity 112. Accordingly, housing 110 can be provided in any shape and with any number of walls as desired, insofar as the resulting shape and walls are functionally compatible with the present invention. As illustrated in FIG. 1, housing 110 can be provided as a parallelepiped. However, housing 110 can be provided as any one or more of, in whole or in part, a cube, prism, pyramid, sphere, cone, cylinder, or any other symmetrical and asymmetrical shape that is functionally compatible with the present invention.

As further illustrated in FIG. 1, housing 110 can include an input aperture 113 having an optional input cover 114 located on an upper portion 115 of the housing, and an output aperture 116 located on a lower portion 117 of the housing. Notably, cover 114 can be hingedly or slidably mounted to the inside or outside of housing 110, or configured to otherwise sealably engage housing 110. Input aperture 113 can be provided to allow cavity 112 to be filled with feed (not shown), and output aperture 116 can be provided to allow feed to flow, via gravity, out of the cavity. Notably, output aperture 116 can optionally include an output cover (not shown) mounted to the inside or outside of housing 110, with an output cover being used to regulate the exhaust of feed through the output aperture. Further, housing 110 can optionally include a plurality of legs 118, which illustratively, can attach to base 120 and/or provide structure for engaging the ground insofar as desired.

As also illustrated in FIG. 1, base 120 can have a top portion 121 that can be securely attached to housing 110, and a bottom portion 122 that can securely engage a ground surface (not shown). Illustratively, top portion 121 can attach to a plurality of optional legs 118 of housing 110, or alternatively, attach directly to housing 110 in any functionally compatible manner, for example and not in limitation, by welding, bolt-nut combinations, or any other known or apparent connection structure(s) that are functionally consistent with the present invention.

FIG. 1 further illustrates a spreader 130 that can be located directly below output aperture 116. Spreader 130 can be provided in any shape that is functionally compatible with the present invention, such that the spreader spreads feed exhausted from cavity 112.

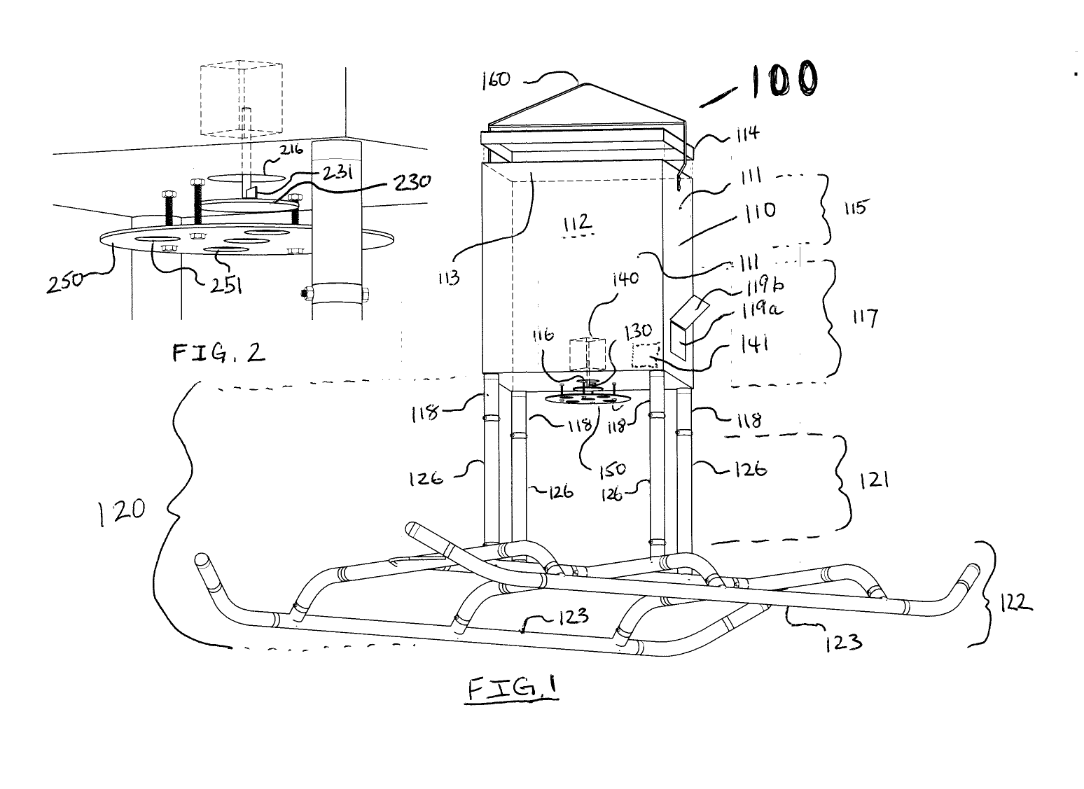

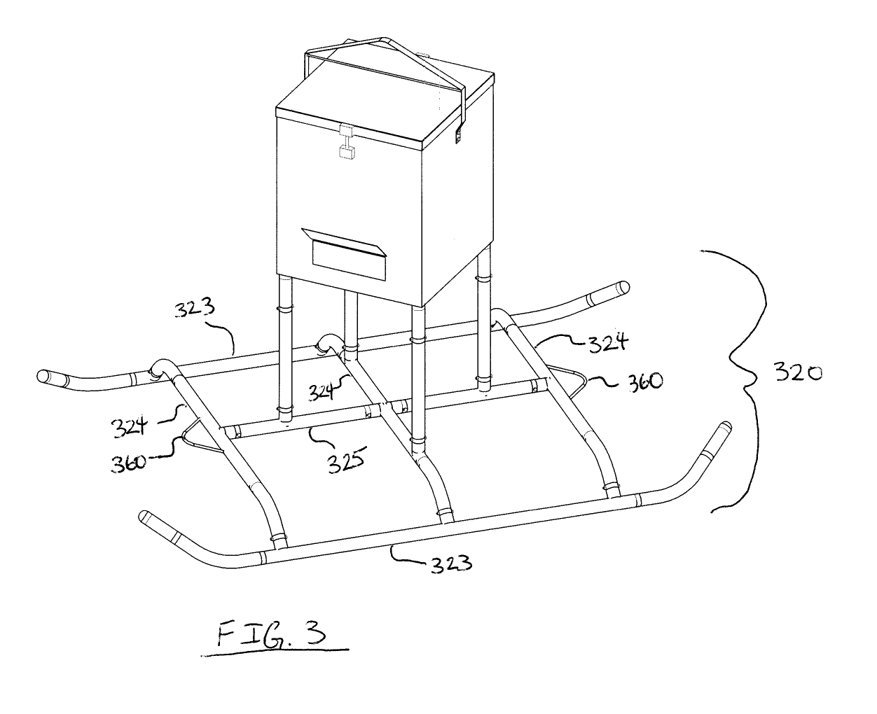

FIG. 2 illustrates further exemplary aspects of the present invention. For example and not in limitation, spreader 230 can be provided as an at least substantially flat plate; however, spreader 230 can alternatively be provided in any functionally compatible shape desired that is functionally consistent with the present invention. For example and not in limitation, spreader 230 can be provided as a single tab or sweep arm as illustrated in FIG. 2, a plate beveled towards housing 110 or the ground (not shown), a straight, curved, or irregularly shaped tab or arm, etc. (not shown). Notably, spreader 230 can be provided with or without its own a plate element, with the latter option utilizing a varmint guard 250 as a plate. In an exemplary aspect, spreader 230 can include one or more tabs 231 (i.e., sweep arms) that can apply a force to exhausted feed when the spreader is rotated, resulting in such feed being spread away from the spreader. Notably, spreader 230 can alternatively include one or more directional chutes or channels, in which case exhausted feed can be directionally spread with or without rotation of the spreader.

Referring again to FIG. 1, in another exemplary aspect, a motor 140 can be, securely attached to game feeder 100 and to spreader 130, and configured to rotate the spreader when activated. In a further exemplary aspect, activation of motor 140 can be effectuated manually via a switch, for example and not in limitation; or automatically via a programmable timer 141 or photoelectric switch (e.g., at dawn, dusk, sunrise, etc.), for example and not in limitation. Notably, manual activation can be effectuated via a user's physical manipulation of an on-board switch, or via a remote manner, such as via a wireless remote control or via a computer network, such as the Internet, in which case a wired or wireless network interface can be provided. As further illustrated in FIG. 1, motor 140 and/or a timer 141 can be mounted inside of housing 110 for protection against damage by varmints; and in such a case, housing 110 can include an optional access aperture 119a and access cover 119b, with the later being mounted to the inside or outside of housing 110.

In yet another exemplary aspect, motor 140 can be mechanical or electrical. If mechanical, motor 140 can include a potential energy storage cell, such as a mainspring, for example and not in limitation, with a winding mechanism. Accordingly, a timer 141 can be configured to transfer stored energy from the storage cell to motor 140, so as to rotate spreader 130, which can be based on a schedule. If electrical, motor 140 can have a power supply for electrically energizing the motor. Any form of power supply can be utilized with the present invention, insofar as the same is functionally compatible therewith. For example and not in limitation, a power supply can be one or more of a battery, which can optionally be rechargeable, an alternating current source with an AC/DC converter, and a solar cell. As with a mechanical motor, timer 141 can be configured to transfer power from the power supply to motor 140 so as to rotate spreader 130, which can be based on a schedule, in which case timer 141 can be programmable.

In an exemplary aspect, to the extent an optional timer 141 is utilized with the present invention, any type of functionally compatible timer can be used. For example, and not in limitation, timer 141 can be mechanical or electrical. Further, timer 141 can be provided with a photoelectric switch and/or a programmable scheduler.

In still another exemplary aspect of the present invention, any one or more elements of the present invention can be formed of one or more rigid materials that provide protection from varmints. Exemplary materials can include one or more of a metal, alloy, plastic, wood, crystal, ceramic, steel, aluminum, high density plastic, etc., for example and not in limitation. In addition to inherent strength, such one or more materials can be particularly shaped to increase overall strength, such as tubular, channeled, pyramidal, oval, elliptical, etc. Moreover, such one or more materials can be selected for greater weight characteristics, which can assist in rendering game feeder 100 resistant to being tipped over by a varmint, which can be substantially sized, such as where a varmint is an adult bear.

In exemplary operational aspects of game feeder 100, cavity 112 can be filled with feed via input aperture 113. Exemplary feed can be provided as particles having one or more of various sizes. Exemplary feed types can include one or more of corn kernels, pellets, nuts, and various other man-made or naturally-occurring particles or liquids. Upon filling, feed can be gravity-biased to exhaust through output aperture 116 and abut spreader 130, which when not rotating, can provide an abutment structure that temporarily terminates such exhaust until spreader 130 is rotated. Where feed includes one or more liquids and/or solids, an optional output cover (supra, not shown) can be utilized to regulate the exhaust of feed. In still a further exemplary aspect, when spreader 130 is rotated via motor 140, the spreader can spread exhausted feed away from the spreader, such that the feed can attract and be consumed by game.

In another exemplary aspect, game feeder 100 can optionally include a varmint guard 150 disposed directly below output aperture 116 and securely attached to housing 110, such that spreader 130 is disposed between the varmint guard and the housing. As illustrated in FIG. 2, varmint guard 250 can optionally include a plurality of guard holes 251, which in one exemplary aspect, can allow feed to fall there through.

In still a further exemplary aspect, a clearance distance between varmint guard 150 and housing 110 can be minimized so as to allow rotation of spreader 130 and spreading of feed, but also to prevent or reduce the accessibility or potential damage to spreader 130 by a varmint. For example and not in limitation, where feed particles are no greater than 0.125 inches, the clearance distance can be about 0.125 inches. It should be noted that the existence of spreader 130 between varmint guard 150 and housing 110 can be considered, and thus, spreader 130 can be provided with a minimal thickness that does not necessitate a greater clearance distance than needed to allow feed to be spread. In another exemplary aspect, a clearance distance can between about 0.125 inches and about 3.0 inches, and in any measurable increment there between. Further, notably, varmint guard 150 can be attached to housing 110 in any apparent manner that allows a clearance distance to be adjustable. For example and not in limitation, varmint guard 150 can be attached to housing 110 via threaded elements, such as bolts, which can be rotated to increase or decrease the clearance distance.

In another exemplary aspect, base 120 can be provided as a single formed unit, or can be provided as a plurality of base components that are configured to securely connect together to form the base. Connection can be effectuated in any functionally compatible manner, such as, for example and not in limitation, by bolt-nut combinations, clamps, and/or complementarily shaped connection points, etc. Notably, this latter aspect can improve transportation and/or storage of game feeder 100, including but not limited to, shipping.

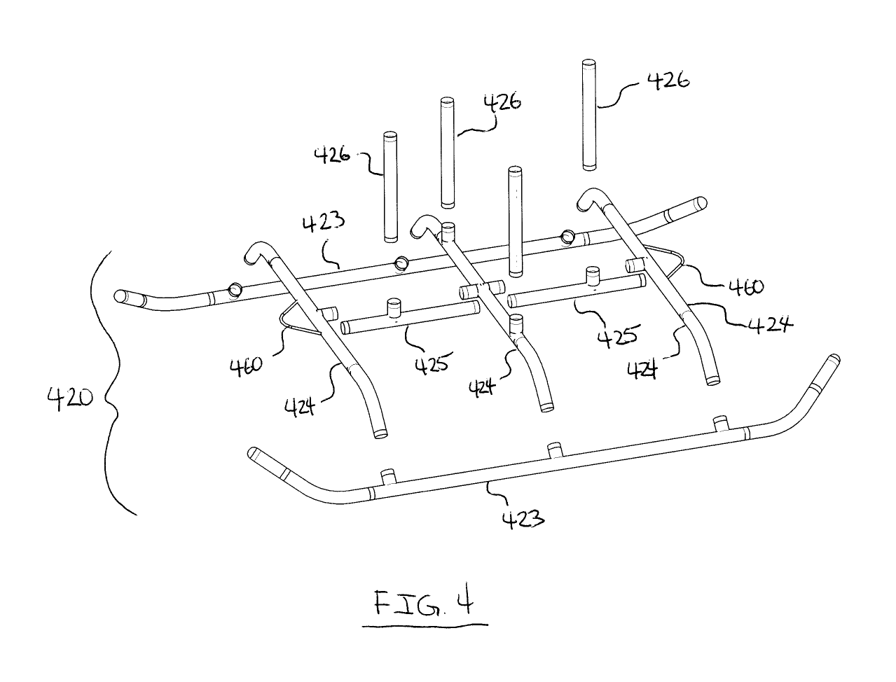

As further illustrated in FIG. 1, base 120 can include a plurality of rails 123 that can be configured to be aligned in parallel when the components are securely connected together, which can render the game feeder more easily slidable along a ground surface. As illustrated in FIG. 3, base 320 can include one or more cross members 324 configured to securely connect together at least two rails 323. As additionally illustrated, base 320 can include at least one cross elements 325 configured to securely connect together at least two cross members 324.

As further illustrated in FIG. 1, and noted above, in another exemplary aspect, lower portion 117 of housing 110 can optionally include a plurality of legs 118, with base 120 having a plurality of leg extensions 126 configured to securely engage legs 118.

As further illustrated in FIG. 3, game feeder 100 can further include at least one loop 160 disposed on upper portion 115 of housing 110 for hanging the game feeder from a structure, such as for example and not in limitation, a tree, a stand, etc. Alternatively or conjunctively, as illustrated in FIG. 3, game feeder 300 can optionally include at least one loop 360 on base 320 for providing a pulling structure for the game feeder, which can render the game feeder more easily movable via pulling.

FIG. 4 illustrates another, more detailed view of an exemplary aspect of the present invention, in which base 420 can optionally be provided as a plurality of base components that are configured to securely connect together to form the base. As illustrated, base 420 can include a plurality of rails 423 that can be configured to be aligned in parallel when the components are securely connected together, which can render the game feeder more easily slidable along a ground surface. As illustrated in FIG. 4, base 420 can include one or more cross members 424 configured to securely connect together at least two rails 423. As additionally illustrated, base 420 can include at least one cross elements 425 configured to securely connect together at least two cross members 424.

It will be apparent to one of ordinary skill in the art that the manner of making and using the claimed invention has been adequately disclosed in the above-written description of the exemplary embodiments and aspects. It should be understood, however, that the invention is not necessarily limited to the specific embodiments, aspects, arrangement, and components shown and described above, but may be susceptible to numerous variations within the scope of the invention. Moreover, particular exemplary features described herein in conjunction with specific embodiments and/or aspects of the present invention are to be construed as applicable to any embodiment described within, enabled hereby, or apparent herefrom. Thus, the specification and drawings are to be regarded in a broad, illustrative, and enabling sense, rather than a restrictive one.

Further, it will be understood that the above description of the embodiments of the present invention are susceptible to various modifications, changes, and adaptations, and the same are intended to be comprehended within the meaning and range of equivalents of the appended claims.

Therefore, I claim:

1. A game feeder, comprising:
a housing formed by at least one wall, defining a cavity, and having an input aperture disposed on an upper portion of said housing and an output aperture disposed on a lower portion of said housing;
a base having a top portion securely attached to said housing, and a bottom portion configured to securely engage a ground surface;
a spreader disposed directly below the output aperture;
a varmint guard disposed below the output aperture and securely attached to said housing, such that said spreader is disposed between said varmint guard and said housing; and
a motor, securely attached to said game feeder and to said spreader, and configured to rotate said spreader when activated;
wherein said housing, base, and spreader are formed of one or more rigid materials, when said housing is filled with feed via the input aperture, the feed is gravity-biased to exhaust through the output aperture and to statically abut said spreader when said spreader is static, and when said spreader is rotated via said motor, said spreader spreads exhausted feed away from said spreader.

2. The game feeder of claim 1, wherein said varmint guard includes a plurality of guard holes.

3. The game feeder of claim 1, wherein a clearance distance between said varmint guard and said housing is less than about 1.75 inches.

4. The game feeder of claim 1, wherein a clearance distance between said varmint guard and said housing is less than about 1.5 inches.

5. The game feeder of claim 1, wherein a clearance distance between said varmint guard and said housing is less than about 1.25 inches.

6. The game feeder of claim 1, wherein a clearance distance between said varmint guard and said housing is less than about 1 inch.

7. The game feeder of claim 1, wherein a clearance distance between said varmint guard and said housing is less than about 0.75 inches.

8. The game feeder of claim 1, wherein a clearance distance between said varmint guard and said housing is less than about 0.5 inches.

9. The game feeder of claim 1, wherein a clearance distance between said varmint guard and said housing is less than about 0.25 inches.

10. The game feeder of claim 1, wherein said spreader is a spreader plate having at least one tab.

11. The game feeder of claim 1, further comprising
a timer;
wherein said motor is a mechanical motor having a potential energy storage cell, and said timer is configured to transfer stored energy from the storage cell to said motor so as to rotate said spreader according to a schedule.

12. The game feeder of claim 1, further comprising
a timer;
wherein said motor is an electrical motor having a power supply, and said timer is configured to transfer power from the power supply to said motor so as to rotate said spreader based on a schedule.

13. The game feeder of claim 1, wherein said motor is disposed within the cavity, and said housing includes an access aperture for accessing said timer.

14. The game feeder of claim 1, wherein said base is provided as a plurality of base components that are configured to securely connect together to form said base.

15. The game feeder of claim 14, wherein the plurality of base components includes a plurality of rails configured, to be aligned in parallel when said plurality of components is securely connected together, and to render the game feeder slidable along the ground surface.

16. The game feeder of claim 15, wherein the plurality of base components further includes a plurality of cross members configured to securely connect together at least two of said plurality of rails.

17. The game feeder of claim 16, wherein the plurality of base components further includes at least one cross element configured to securely connect together at least two of the plurality of cross members.

18. The game feeder of claim 1, wherein the lower portion of said housing includes a plurality of legs, and said base includes a plurality of leg extensions configured to securely engage said legs.

19. The game feeder of claim 1, further comprising one or more loops disposed on at least one of the upper portion of said housing, for hanging the game feeder, and said base, for pulling the game feeder.

20. A game feeder, comprising:
a housing formed by at least one wall, defining a cavity, and having an input aperture disposed on an upper portion of said housing and an output aperture disposed on a lower portion of said housing;
a spreader disposed directly below the output aperture;
a varmint guard disposed directly below the output aperture and securely attached to said housing, such that said spreader is disposed between said varmint guard and said housing;
a motor, securely attached to said game feeder and to said spreader, and configured to rotate said spreader when activated; and
a loop disposed on an upper portion of the housing for hanging the feeder from a structure;
wherein said housing, spreader, and varmint guard are formed of one or more rigid materials, when said housing is filled with feed via the input aperture, the feed is gravity-biased to exhaust through the output aperture and to statically abut said spreader when said spreader is static, and when said spreader is rotated via said motor, said spreader spreads exhausted feed, between said base and said varmint guard, and away from said spreader.
